(19) United States
(12) Patent Application Publication
(10) Pub. No.: US 2017/0253096 A1
(43) Pub. Date: Sep. 7, 2017

(54) TRAILER ARM COMPONENT

(71) Applicant: Ningbo Yinzhou Longteng Tool Factory, Ningbo (CN)

(72) Inventor: Guanglong LI, Ningbo (CN)

(73) Assignee: Ningbo Yinzhou Longteng Tool Factory, Ningbo (CN)

(21) Appl. No.: 14/898,749

(22) PCT Filed: Sep. 17, 2015
(86) PCT No.: PCT/CN2015/089862

§ 371 Date: Dec. 16, 2015

(30) Foreign Application Priority Data
Sep. 8, 2015 (CN) 201510566204.6

(51) Int. Cl. B60D 1/07; B60D 1/58; B60D 1/06

(52) U.S. Cl. CPC B60D 1/075; B60D 1/06; B60D 1/58

(57) ABSTRACT

The present invention provides a trailer arm component in the technical field for vehicle traction device, which improves poor stability of the existing trailer arms. The trailer arm component or the invention comprises a connection arm; a support arm which is connected with the connection arm and has a mounting hole; a primary ball head having an extension part which has a cylindrical shape and is inserted into the mounting hole; and a secondary ball head having a mounting part which is inserted into the extension part and threaded with the extension part. The present invention provides the advantages including a simple structure, firm connection and better stability.

### BACKGROUND OF THE INVENTION

Field of Invention

The present invention relates to the technical field for vehicle traction device, and in particular, to a trailer arm component.

Related Art

The conventional trailer arm component generally comprises a trailer arm body and a trailer ball head connected to the trailer arm body, in which the trailer arm body is usually mounted on the traction vehicle and the trailer ball head is usually connected to a towed vehicle, for example a towed vehicle that has suffered mechanical failure. There are generally two trailer ball heads in the prior art, which are inserted into the trailer arm body from up and down respectively In particular, a sleeve is mounted on the trailer arm body, an inner thread is provided on the inner wall of the sleeve, and two trailer ball heads have outer threads to be connected within the sleeve. In such a configuration two trailer ball heads could be fixed to the trailer arm body. However, as two trailer ball heads are inserted into the sleeve together, the ends of the two trailer ball heads are pressed against each other in the sleeve. To this end, the trailer ball heads tend to run in an axial direction on the trailer arm body, which brings poor stability, after the trailer ball heads are mounted on the trailer arm body.

### SUMMARY OF THE INVENTION

In order to address the aforesaid defects existing in the poor art, the present invention provides a trailer arm component which has a simple structure, firm connection and better stability.

It is therefore an object of the present invention to provide a trailer arm component, comprising a connection arm; a support arm which is connected with the connection arm and has a mounting hole; a primary ball head having an extension part which has a cylindrical shape and is inserted into the mounting hole; and a secondary ball head having a mounting part which is inserted into the extension part and threaded with the extension part.

In the said trailer arm component, the primary ball head further comprises a primary ball head part of a spherical shape; arid a disk-like position limiting part located between the primary ball head part and the extension part, which has an outer diameter larger than the diameter of the mounting hole.

In the said trailer arm component, the secondary ball head further comprises a secondary ball bead part of a spherical shape; and a disk-like locating part positioned between the secondary ball head part and the mounting part, which has an outer diameter larger than the diameter of the mounting hole.

In the said trailer arm component, the length of the mounting part is less than the length of the extension part.

In the said trailer arm component, a concave hole is opened on each of the end face of the primary ball head part and the end face of the secondary ball head part.

In the said trailer arm component, the concave hole has a hexagonal section.

In the said trailer arm component, the trailer ball component further comprises a latch extending between the connection arm and the support arm, in which a barrier part is curvedly formed at one end of the latch and an insertion hole is opened in a radial direction at the other end; and a buckle composed of an insertion part and a fixing part integrated with each other, in which the insertion part passes through the insertion hole and the fixing part is pressed against the outer wall of the latch.

In the said trailer arm component, the connection arm is of an “L”-shape and composed of a fixed part and a connecting part, a plurality of locating holes are evenly opened on the fixed part and the connecting part, and the latch passes through one of the locating holes on the connecting part.

In the said trailer arm component, the support arm has two symmetrically disposed claw parts, the outer ends of the said two claw parts are both folded inward to form two couple parts, two chutes are symmetrically opened on the outer wall of the connecting part of the connection arm, the fixed part of the connection arm is located between the said two claw parts and each of the couple parts could move in the corresponding chute.

In the said trailer arm component, a counterbore is provided on each of both ends of the mounting hole of the support arm, a cushion block is mounted within the counterbore, and each al the primary ball head and the secondary ball head passes through the corresponding cushion block respectively.

The present invention has the following advantages over the prior art.

First, the sleeve that used to connect the primary ball head with the secondary ball head is configured to be integral with the primary ball head, which not only saves the portion of the primary ball head that used to connect with the sleeve and reduces the production cost, but also the mounting part of the secondary ball head directly passes into and is threaded with the extension part of the primary ball head. The pitch between the secondary ball head and the primary ball head is thus prolonged, which provides firmer connection between the secondary ball head and the primary ball head. Meanwhile, the secondary ball head and the primary ball head are pressed against the support arm to prevent axial run and provide better stability, after the secondary ball head and the primary ball head are mounted on the support arm.

Second, when the trailer arm component is mounted between the traction vehicle and the towed vehicle, a horizontal force and a vertical force will be generated simultaneously between the connection arm and the support arm. By passing the insertion part of the buckle through the latch and pressing the fixing part of the buckle against the latch, the buckle could be firmly mounted on the latch, so that the connection arm could be firmly connected with the support arm by the action of the buckle and the barrier part of the latch together. Therefore, the latch will not be released from the connection arm or the support arm.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a structural diagram of the invention

FIG. 2 is a sectional view of the primary ball head in this invention;

FIG. 3 is a sectional view of the secondary ball head in this invention;

FIG. 4 is a structural diagram of the support arm in the invention, and

FIG. 5 is a structural diagram of the latch in the invention.

### DETAILED DESCRIPTION OF THE INVENTION

Embodiments of the present invention will be described in detail below with reference to the drawings. However, the present invention shall not be limited to these embodiments.

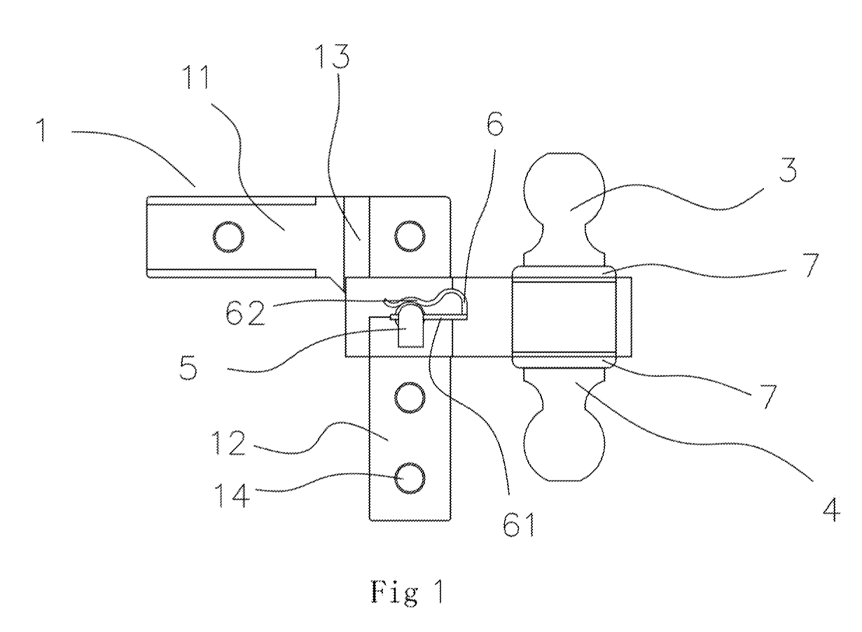

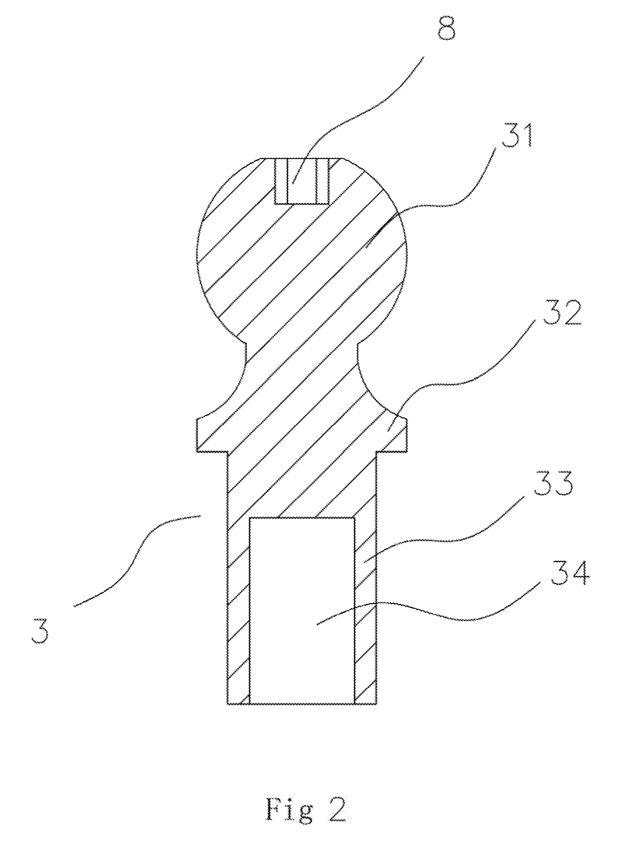

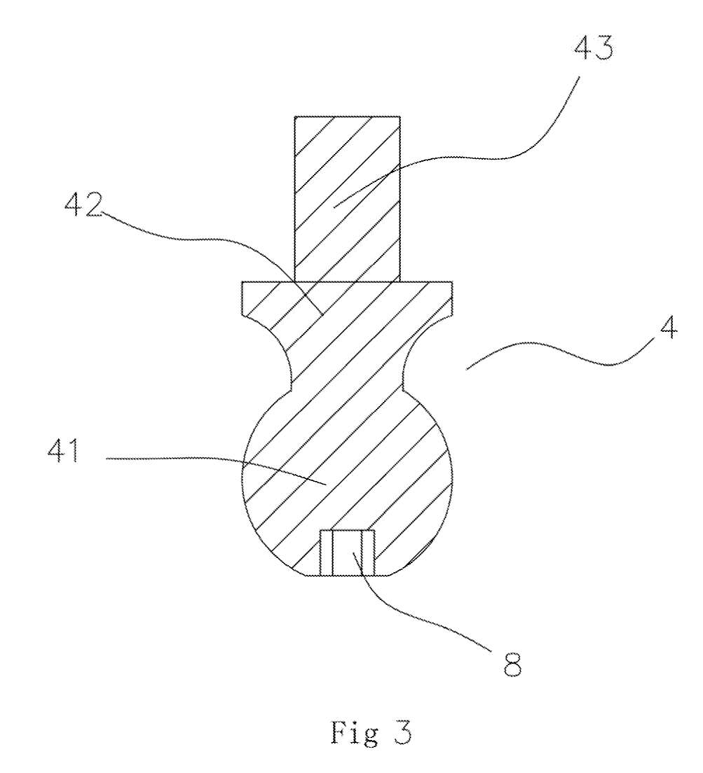

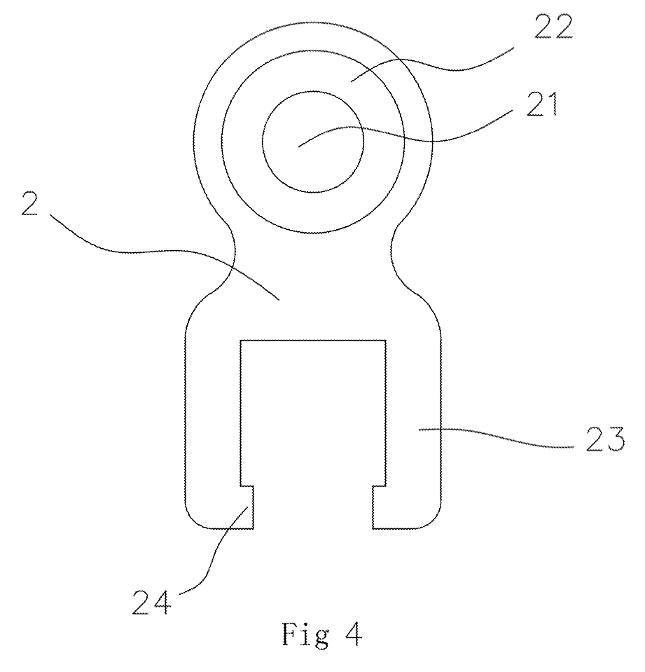

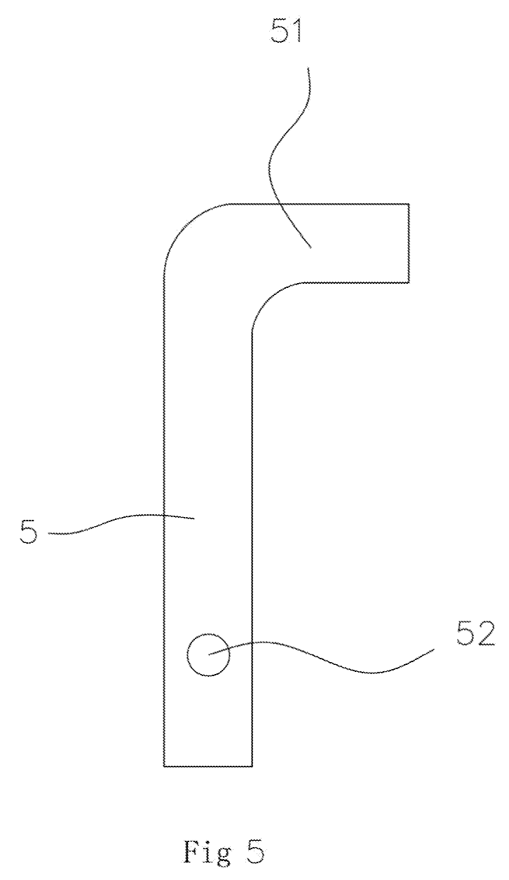

As shown in FIGS. 1-5, the trailer arm component of the invention comprises a connection arm 1, a support am 2, a primary ball head 3, and a secondary ball head 4, in which the support arm 2 is connected with the connection arm 1, and the support arm 2 has a mounting hole 21; the primary ball head 3 has an extension part 33 which has a cylindrical shape and is inserted into the mounting hole 21; and the secondary ball head 4 has a mounting part 43, and the mounting part 43 is inserted into the extension part 33 and threaded with the extension part 33.

In the trailer arm component of the invention, the sleeve that used to connect the primary ball head 3 with the secondary ball head 4 is integrated with the primary head 3, which not only saves the portion of the primary ball head 3 that used to connect with the sleeve, but also the mounting part 43 of the secondary ball head 4 directly passes into and is threaded with the extension part 33 of the primary ball head 3. In particular, an outer thread is provided on the outer wall of the mounting part 43 of the secondary ball head 4, a via hole 34 is provided in the extension part 33 of the primary ball head 3, an inner thread is provided on the inner wall of the via hole 34, and the mounting part 43 of the secondary ball head 4 is screwed into the via hole 34 of the extension part 33 of the primary ball head 3. As such, the pitch between the secondary ball head 4 and the primary ball head 3 is prolonged. That is to say, the screwed thread portion of the primary ball head 3 connected with the secondary ball head 4 is prolonged, which makes the connection of the secondary ball head 4 with the primary ball head 3 securer, and the secondary ball head 4 and the primary ball head 3 pressed against the support arm 2 to prevent axial run and provide better stability, after the secondary ball head 4 and the primary ball head 3 are mounted on the support arm 2. Meanwhile, the sleeve is saved so that the primacy ball head 3 is firstly inserted onto the support arm 2, the secondary ball head 4 is then inserted onto the primary ball head 3, and the primary and secondary ball heads 3 and 4 are rotated to be screwed, which facilitates mounting.

Further, the length of the mounting part 43 is less than that of the. extension part 33. Particularly, the length of the mounting part 43 provided with an outer thread is less than the depth of the via hole 34 of the extension part, so that when the secondary ball head 4 of the mounting part 43 is screwed into the extension part 33 of the primary ball head 3, the extension part 33 has enough space to make the mounting part 43 screwed toward the interior of the extension part 33. Consequently, the secondary ball head 4 and the primary ball head 3 are pressed against the support arm 2 to prevent axial run and provide better stability, after the secondary ball head 4 and the primary ball head 3 are mounted on the support arm 2.

In addition, the primary ball head 3 further includes a spherical primary ball head part 31 and a disk-like position limiting part 32. The position limiting part 32 is located between the primary ball head part 31 and the extension part 33. The outer diameter of the position limiting part 32 is larger than the diameter of the mounting hole 21. The primary ball head part 31 is mainly used for connection with a towed vehicle, e.g. a pulled vehicle in failure. The outer diameter of the position limiting part 32 is larger than the diameter of the mounting hole 21, so that when the primary ball head 3 and the secondary ball head 4 are together fixed within the mounting hole 21 of the support arm 22, the position limiting part 32 is pressed against the end of the mounting hole 21. Therefore, the primary ball head 3 and the secondary ball head 4 will not axially run after being fixed to each other, which provides better stability.

Furthermore, the secondary ball head 4 includes a spherical secondary ball head part 41 and a disk-like locating part 42. The locating part 42 is positioned between the secondary ball head part 41 and the mounting part 43. The outer diameter of the locating part 42 is larger than the diameter of the mounting hole 21. The secondary ball head part 41 and locating part 42 on the secondary ball head 4 and have the same function as the primary ball head part 31 and the position limiting part 32 on the primary ball head 3.

Further, a concave hole 8 is opened on each of the end filet of the primary ball head part 31 and the end face of the secondary ball head part 41. A wrench is inserted into the concave hole 8 so that the primary ball head 3 is screwed with the secondary ball head 4, which provides more reliable connection and better stability. In the meantime, the concave hole 8 is opened on the end face of the ball head in such a manner that the wrench will not face the ball head surface when the wrench is inserted into the concave hole 8 to rotate the ball head by force.

Additionally, the concave hole 8 has a hexagonal section, which facilitates connection with the wrench. By using such a configuration, the secondary ball head 4 or primary ball head 3 could be conveniently rotated after the wrench is inserted into the concave hole 8.

Further, the trailer ball component of the invention additionally comprises a latch 5 and a buckle 6, in which the latch 5 extends between the connection arm 1 and the support arm 2. A barrier part 51 is curvedly formed at one end of the latch 5 and an insertion hole 52 is opened in a radial direction at the other end. The buckle 6 is composed of an insertion part 61 and a fixing part 62 which are integrated with each other. The insertion part 61 passes through the insertion hole 52, and the fixing part 62 is pressed against the outer wall of the latch 5. The latch 5 is mainly used to connect the connection arm 1 with the support arm 2. When the trailer arm component is mounted between the traction vehicle and the towed vehicle, a horizontal force and a vertical force will be generated simultaneously between the connection arm 1 and the support arm 2. By passing the insertion part 61 of the buckle 6 through the latch 5 and pressing the fixing part 62 of the buckle 6 against the latch 5, the buckle 6 could be firmly mounted on the latch 5, so that the connection arm 1 could be firmly connected with the support arm 2 by the action of the buckle 6 and the barrier part 51 of the latch 5 together. Therefore, the latch 5 will not be released from the connection arm or the support arm 2.

Furthermore, the connection arm 1 is of an “L”-shape and composed of a fixed part 11 and a connecting part 12. A plurality of locating holes 14 are evenly opened on the fixed part 11 and the connecting part 12. The latch 5 passes through one of the locating holes 14 on the connecting part 12. The fixed part 11 is mainly used for connecting with the traction vehicle. The plurality of mounting holes 21 are opened so that the support arm 2 could be adjusted to be mounted on different positions of the connection arm 1 depending on the model of the vehicles.

Further, the support arm 2 has two symmetrically disposed claw parts 23. The outer ends of the said two claw parts 23 are both folded inward to form two couple parts 24. Two chutes 13 are symmetrically opened on the outer wall of the connecting part 12 of the connection arm 1. The fixed part 11 of the connection arm 1 is located between two claw parts 23 and each of the couple pans 24 could move in the corresponding chute 13. The connection arm 1 is coupled with the support arm 2 through the claw pans 23 and couple parts 24, so that the connection arm 1 is circumferentially fixed on the support arm 2. Meanwhile, the couple parts 24 could slide within the chutes 13, which facilitates operation to connect the support arm 2 with the connection arm 1.

Further, a counterbore 22 is provided on each of both ends of the mounting hole of the support arm. A cushion block 7 is mounted within the counterhore 22. Each of the primary ball head 3 and the secondary ball head 4 passes through the corresponding cushion block 7 respectively.

The specific embodiments described herein are merely illustrative of the spirit of the invention. It is apparent to those skilled in the art that various modifications, amendments and alternatives can be made to these embodiments without departing from the spirit or scope defined by the appended claims.

### REFERENCE NUMERALS

1 connection arm

11 Fixed Part

12 Connecting Part

13 Chute

14 Locating Hole

2 Support Arm

21 Mounting Hole

22 Counterbote

23 Claw Part

24 Couple Part

3 Primary Ball Head

31 Primary Ball Head Part

32 Position Limiting Part

33 Extension Part

34 Via Hole

4 Secondary Ball Head

41 Secondary Bali Head Part

42 Locating Part

43 Mounting Part

5 Latch

51 Barrier Part

52 Insertion Hole

6 Buckle

61 Insertion Part

62 Fixing Part

7 Cushion Block

8 Concave Hole

1. A trailer arm component, comprising:
a connection arm;
a support arm which is connected with the connection arm and has a mounting hole;
a primary ball head having an extension part which has a cylindrical shape and is inserted into the mounting hole; and
a secondary ball head having a mounting part which is inserted into the extension part and threaded with the extension part.

2. The trailer arm component according to claim 1, wherein in the trailer arm component and the length of the mounting part is less than that of the extension part.

3. The trailer arm component according to claim 1, wherein the primary ball head further comprises
a primary ball head part of a spherical shape; and
a disk-like position limiting part located between the primary ball head part and the extension part, which has an outer diameter larger than the diameter of the mounting hole.

4. The trailer arm component according to claim 3, wherein the secondary ball head further comprises
a secondary ball head part of a spherical shape; and
a disk-like locating part positioned between the secondary ball head part and the mounting part, which has an outer diameter larger than the diameter of the mounting hole.

5. The trailer arm component according to claim 4, wherein a concave hole is opened on each of the end face of the primary ball head part and the end face of the secondary ball head part.

6. The trailer arm component according to claim 5, wherein each of the sections of the concave holes is hexagonal.

7. The trailer arm component according to claim 1, wherein the trailer ball component further comprises
a latch extending between the connection arm and the support arm, in which a barrier part is curvedly formed at one end of the latch and an insertion hole is opened in a radial direction at the other end; and
a buckle composed of an insertion part and a fixing part integrated with each other, in which the insertion part passes through the insertion hole and the fixing part is pressed against the outer wall of the latch.

8. The trailer ann component according to claim 7, wherein the connection arm is of an “L”-shape and composed of a fixed part and a connecting part, a plurality of locating holes are evenly opened on the fixed part and the connecting part, and the latch passes through one of the locating holes on the connecting part.

9. The trailer arm component according to claim 8, wherein the support arm has two symmetrically disposed claw parts, the outer ends of the said two claw parts are both folded inward to form two couple parts, two chutes are symmetrically opened on the outer wall of the connecting part of the connection arm, the fixed part of the connection arm is located between the said two claw parts and each of the couple parts could move in the corresponding chute.

10. The trailer arm component according to claim 1, wherein a counterbore is provided on each of both ends of the mounting hole of the support ann, a cushion block is mounted within the counterbore, and each of the primary ball head and the secondary ball head passes through the corresponding cushion block respectively.

11. The trailer arm component according to claim 2, wherein the primary ball head further comprises
a primary ball head part of a spherical shape; and
a disk-like position limiting part located between the primary ball head part and the extension part, which has an outer diameter larger than the diameter of the mounting hole.

12. The trailer arm component according to claim 11, wherein the secondary ball head further comprises
a secondary ball head part of a spherical shape; and
a disk-like locating part positioned between the secondary ball head part and the mounting part, which has an outer diameter larger than the diameter of the mounting hole.

13. The trailer arm component according to claim 12, wherein a concave hole is opened on each of the end face of the primary ball head part and the end face of the secondary ball head part.

14. The trailer arm component according to claim 13, wherein each of the sections of the concave holes is hexagonal.

15. The trailer arm component according to claim 2, wherein the trailer ball component further comprises
a latch extending between the connection arm and the support arm, in which a barrier part is curvedly formed at one end of the latch and an insertion hole is opened in a radial direction at the other end; and
a buckle composed of an insertion part and a fixing part integrated with each other, in which the insertion part passes through the insertion hole and the fixing part is pressed against the outer wall of the latch.

16. The trailer arm component according to claim 15, wherein the connection arm is of an “L”-shape and composed of a fixed part and a connecting part, a plurality of locating holes are evenly opened on the fixed part and the connecting part, and the latch passes through one of the locating holes on the connecting part.

17. The trailer arm component according to claim 16, wherein the support arm has two symmetrically disposed claw parts, the outer ends of the said two claw parts are both folded inward to form two couple parts, two chutes are symmetrically opened on the outer wall of the connecting part of the connection arm, the fixed part of the connection arm is located between the said two claw parts and each of the couple parts could move in the corresponding chute.

18. The trailer arm component according to claim 2, wherein a counterbore is provided on each of both ends of the mounting hole of the support arm, a cushion block is mounted within the counterbore, and each of the primary ball head and the secondary ball head passes through the corresponding cushion block respectively.
